(19) United States
(12) Patent Application Publication
(10) Pub. No.: US 2025/0058746 A1
(43) Pub. Date: Feb. 20, 2025

(54) BRAKING CONTROL DEVICE FOR VEHICLE

(71) Applicant: ADVICS CO., LTD., Kariya-shi, Aichi-ken (JP)

(72) Inventors: Daichi NAGAE, Kariya-shi, Aichi-ken (JP); Takayuki YAMAMOTO, Kariya-shi, Aichi-ken (JP); Yoshio MASUDA, Kariya-shi, Aichi-ken (JP)

(73) Assignee: ADVICS CO., LTD., Kariya-shi, Aichi-ken (JP)

(21) Appl. No.: 18/721,232

(22) PCT Filed: Dec. 22, 2022
(86) PCT No.: PCT/JP2022/047392

§ 371 Date: Jun. 18, 2024

(30) Foreign Application Priority Data
Dec. 22, 2021 (JP) 2021-208677

(51) Int. Cl. B60T 8/172; B60T 8/171

(52) U.S. Cl. CPC B60T 8/172; B60T 8/171; B60T 2201/03; B60T 2220/04; B60T 2270/402; B60T 2270/404; B60T 2270/406

(57) ABSTRACT

This braking control device comprises a first unit for outputting a supply pressure in accordance with operation displacement of a braking operation member, a second unit between the first unit and a wheel cylinder to increase the supply pressure and output a wheel pressure to the wheel cylinder, a displacement sensor for detecting the operation displacement, and a supply pressure sensor for detecting the supply pressure. The first unit selects either a first mode in which the operation displacement and the supply pressure are independent or a second mode in which the operation displacement and the supply pressure are linked. When the displacement sensor is normal, the first unit selects the first mode and increases the supply pressure based on the operation displacement. When the displacement sensor is not normal, the first unit selects the second mode, and the second unit increases the wheel pressure based on the supply pressure.

### TECHNICAL FIELD

The present disclosure relates to a braking control device for a vehicle.

### BACKGROUND ART

For the purpose of “generating a braking force as requested by a driver in the same way as a normal time, even if a brake booster fails”, Patent Literature 1 describes that “This brake control system is provided with: a first control device having a first brake operation amount detection device; and a second control device performing a different control from that of the first control device and having a second brake operation amount detection device. The second control device may be provided with: a master pressure acquiring part for acquiring master pressure; and a failure detecting part for detecting a failure of the first control device, based on the brake operation amount detected by the second brake operation amount detection device and the master pressure obtained by the master pressure acquiring part”.

Furthermore, Patent Literature 1 describes that a braking control device that can cope with an abnormality of an operation displacement sensor, the braking control device including “a master pressure control device that is connected to a first stroke sensor that detects a movement amount of a brake pedal and controls a first drive motor in order to pressurize an operating fluid of a master cylinder and increase a pressure of a wheel cylinder of each wheel, and a wheel pressure control device that is connected to the master pressure control device via a communication line, has a control function different from that of the master pressure control device by controlling a second drive motor un order to increase a pressure of the wheel cylinder of each wheel, and is connected to a second stroke sensor that detects a movement amount of the brake pedal. The wheel pressure control device includes a failure determining part for determining a failure of the master pressure control device on the basis of failure information transmitted from the master pressure control device or a detection result of the failure detecting part that detects communication failure with the master pressure control device by a communication line, and a wheel cylinder pressure controlling part for calculating a target wheel pressure on the basis of a movement amount of a brake pedal detected by a second stroke sensor when the failure determining part determines a failure of the master pressure control device, and supplying power to the second drive motor such that a wheel cylinder pressure of each wheel becomes a target wheel pressure”. That is, in the device of Patent Literature 1, the operation displacement sensor includes two stroke sensors (i.e., the first stroke sensor connected to the master pressure control device and the second stroke sensor connected to the wheel pressure control device). When the master pressure control device is abnormal, the wheel pressure control device performs backup control for adjusting the wheel cylinder pressure of each wheel based on a detection value of the second stroke sensor.

Even if the operation displacement sensor is made redundant, there is a case where the operation displacement sensor becomes abnormal, and information on the operation displacement is not appropriately obtained. For this reason, there is a demand for a device that can perform backup control even when an abnormality occurs in the operation displacement sensor and information on the operation displacement cannot be used.

### CITATIONS LIST

### Patent Literature

Patent Literature 1: JP 2009-227103 A

### SUMMARY

### Technical Problems

An object of the present disclosure is to provide a braking control device for a vehicle that can perform control for complementing an abnormality even in a case where operation displacement information on a braking operation member cannot be obtained due to the abnormality of an operation displacement sensor.

### Solutions to Problems

A braking control device (SC) for a vehicle according to the present disclosure includes: a first unit (SA) that outputs a supply pressure (Pm) in accordance with an operation displacement (Sp) of a braking operation member (BP); a second unit (SB) that is provided between the first unit (SA) and a wheel cylinder (CW), increases the supply pressure (Pm), and outputs a wheel pressure (Pw) to the wheel cylinder (CW); a displacement sensor (SP) that detects the operation displacement (Sp); and a supply pressure sensor (PM) that detects the supply pressure (Pm).

In the braking control device (SC) for a vehicle according to the present disclosure, the first unit (SA) selects any one of a first mode in which the operation displacement (Sp) and the supply pressure (Pm) are independent and a second mode in which the operation displacement (Sp) and the supply pressure (Pm) are linked. In a case of a normal state (FS=0) where the displacement sensor (SP) is normal, the first unit (SA) selects the first mode and increases the supply pressure (Pm) based on the operation displacement (Sp). On the other hand, in a case of an abnormal state (FS=1) where the displacement sensor (SP) is not normal, the first unit (SA) selects the second mode, and the second unit (SB) increases the wheel pressure (Pw) based on the supply pressure (Pm). For example, the first unit (SA) calculates a target pressure (Pt) based on the operation displacement (Sp) and increases the supply pressure (Pm) so as to bring the supply pressure (Pm) close to the target pressure (Pt), and the second unit (SB) calculates an assist pressure (Pc) based on the supply pressure (Pm) and increases the wheel pressure (Pw) based on the assist pressure (Pc).

According to the above configuration, when a signal Sp (operation displacement) of operation displacement, which is an input signal, is not appropriately obtained, an operation force Fp of a braking operation member BP is reduced and the vehicle deceleration is appropriately secured by backup control in which the backup control is performed with a detection result Pm (supply pressure) of a supply pressure sensor PM as an input signal. Furthermore, at normal times of an operation displacement sensor SP, a supply pressure Pm is treated as an output signal of control (i.e., fluid pressure feedback control) for bringing the supply pressure Pm close to a target pressure Pt. On the other hand, at abnormal times of the operation displacement sensor SP, the supply pressure Pm is treated as an input signal of the backup control. Since a detection value Pm of one supply pressure sensor PM is appropriately used, the configuration of the entire device is simplified.

### BRIEF DESCRIPTION OF DRAWINGS

FIG. 1 is a schematic view for explaining an entire vehicle JV mounted with a braking control device SC.

FIG. 2 is a schematic view for explaining a configuration example of a first braking unit SA.

FIG. 3 is a schematic view for explaining a configuration example of a second braking unit SB.

FIG. 4 is a flowchart for explaining processing of pressure adjusting control.

FIG. 5 is a block diagram for explaining drive control of a pressure adjusting valve UA.

FIG. 6 is a block diagram for explaining drive control of a control valve UB.

### DESCRIPTION OF EMBODIMENTS

### <Symbols of Constituent Members and the Like and Suffixes at the End of the Symbols>

In the following description, constituent members, calculation processing, signals, characteristics, and values denoted by identical symbols such as “CW” have identical functions. The suffixes “f” and “r” attached to the end of the symbol related to each wheel are comprehensive symbols indicating which system of front and rear wheels they relate to. For example, wheel cylinders CW provided on the respective wheels are described as “front wheel wheel cylinder CWf” and “rear wheel wheel cylinder CWr”. Furthermore, the suffixes “f” and “r” at the end of the symbols can be omitted. When the suffixes “f” and “r” are omitted, each symbol represents a generic term. For example, “CW” is a generic term for wheel cylinders provided on front and rear wheels of a vehicle.

In a fluid path from a master cylinder CM to a wheel cylinder CW, the side near the master cylinder CM (the side far from the wheel cylinder CW) is called “upper part”, and the side near the wheel cylinder CW (the side far from the master cylinder CM) is called “lower part”. In circulation flows KN and KL of a brake fluid BF in first and second fluid units YA and YB, the side near discharge portions of first and second fluid pumps QA and QB (the side away from a suction portion) is called “upstream side”, and the side near the suction portions of the first and second fluid pumps QA and QB (the side away from the discharge portion) is called “downstream side”.

The first fluid unit YA of the first braking unit SA, the second fluid unit YB of the second braking unit SB, and the wheel cylinder CW are connected by a fluid path (communication path HS). Furthermore, in the first and second fluid units YA and YB, various constituent elements (UA and the like) are connected by a fluid path. Here, the “fluid path” is a route for moving the brake fluid BF, and corresponds to a pipe, a flow path in an actuator, a hose, and the like. In the following description, the communication path HS, a reflux path HK, a return path HL, a reservoir path HR, an input path HN, a servo path HV, a decompression path HG, and the like are fluid paths.

<Vehicle JV Mounted with Braking Control Device SC>

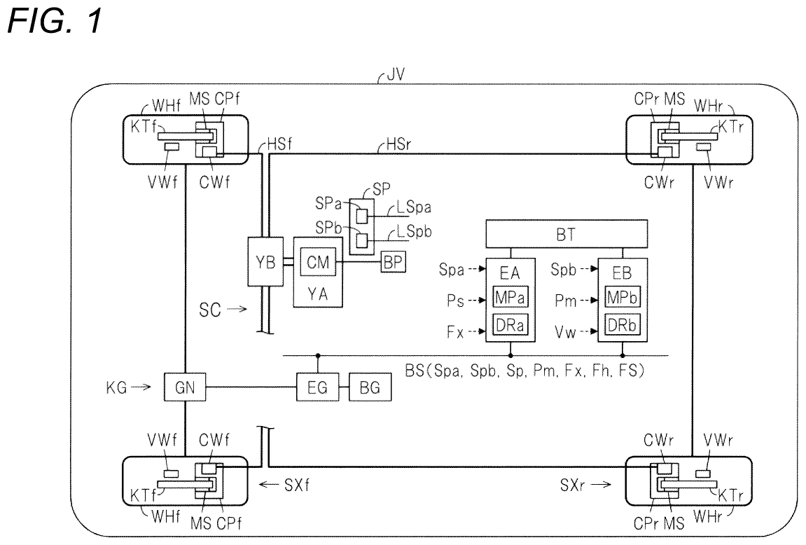

An overall configuration of the vehicle JV mounted with the braking control device SC according to the present disclosure will be described with reference to the schematic view of FIG. 1. The vehicle JV is a hybrid vehicle or an electric vehicle including a driving electric motor. The vehicle JV includes a regenerative device KG. The regenerative device KG includes a generator GN and a control unit EG (also called “regenerative controller”) for the regenerative device. The generator GN is also a driving electric motor. In regenerative braking, the electric motor/generator GN operates as an electrical generator, and the generated electric power is stored in a storage battery BG via the regenerative controller EG. For example, the regenerative device KG is included in a front wheel WHf. In this configuration, a regenerative braking force Fg is generated in the front wheel WHf by the regenerative device KG.

The vehicle JV includes front wheel and rear wheel braking devices SXf and SXr (=SX). The braking device SX includes a brake caliper CP, a friction member MS (e.g., brake pad), and a rotation member (e.g., brake disc) KT. The brake caliper CP is provided with the wheel cylinder CW. The friction member MS is pressed against the rotation member KT fixed to each wheel WH by the fluid pressure Pw (called “wheel pressure”) in the wheel cylinder CW. Due to this, a braking force Fm is generated in the wheel WH. The braking force generated by a wheel pressure Pw is called “friction braking force Fm”.

The vehicle JV includes the braking operation member BP and various sensors (SP and the like). The braking operation member (e.g., brake pedal) BP is a member operated by the driver to decelerate the vehicle JV. The vehicle JV is provided with the operation displacement sensor SP that detects operation displacement Sp of the braking operation member BP. The operation displacement Sp is one of state quantities (state variables) for displaying the operation amount (braking operation amount) of the braking operation member BP, and in the braking control device SC of a brake-by-wire type, the operation displacement Sp is a signal (i.e., braking instruction) indicating the braking intention of the driver.

The operation displacement sensor SP (corresponding to an “operation amount sensor”) includes two detection portions SPa and SPb (“first and second detection portions”). That is, detection of the operation displacement Sp is performed double, and the operation displacement sensor SP is made redundant. The first detection portion SPa (called a “first displacement detection portion”) of the operation displacement sensor SP is connected to the first braking unit SA (in particular, a first control unit EA) by a first displacement signal line LSpa. On the other hand, the second detection portion SPb (called a “second displacement detection portion”) of the operation displacement sensor SP is connected to the second braking unit SB (in particular, a second control unit EB) by a second displacement signal line LSpb. Therefore, a signal Spa (called “first operation displacement”) of the first displacement detection portion SPa is directly input to the first control unit EA. On the other hand, a signal Spb (called “second operation displacement”) of the second displacement detection portion SPb is directly input to the second control unit EB. For example, the “signal lines LSpa and LSpb” are electric wires (wire harnesses) for signal transfer.

In addition to the operation displacement sensor SP, a fluid pressure Ps (called a “simulator pressure”) of a stroke simulator SS is adopted as another state quantity representing a braking operation amount. The simulator pressure Ps is detected by a simulator pressure sensor PS. The simulator pressure sensor PS is connected to the first braking unit SA (in particular, a first control unit EA) by a simulator pressure signal line LPs. Therefore, the simulator pressure Ps is directly input to the first control unit EA. The simulator pressure Ps is a state quantity corresponding to an operation force of the braking operation member BP.

The vehicle JV includes various sensors. A wheel speed sensor VW that detects a rotation speed (wheel speed) Vw of the wheel WH is included. For braking control (called “wheel independent control”) for individually controlling the wheel pressure Pw of each wheel WH, such as anti-lock brake control and anti-skid control, the wheel WH includes the wheel speed sensor VW that detects the rotation speed (wheel speed) Vw thereof. A steering amount sensor that detects a steering amount Sa (e.g., an operation angle of the steering wheel), a yaw rate sensor that detects a yaw rate Yr of the vehicle, a longitudinal acceleration sensor that detects a longitudinal acceleration Gx of the vehicle, and a lateral acceleration sensor that detects a lateral acceleration Gy of the vehicle are included (not illustrated). Each of the signals of the wheel speed Vw, the steering amount Sa, the yaw rate Yr, the longitudinal acceleration Gx, and the lateral acceleration Gy are input to the second braking unit SB (in particular, the second control unit EB) via respective signal lines.

The vehicle JV includes the braking control device SC. In the braking control device SC, a so-called front-rear type (also called “type II”) is adopted as a two-system braking system. The braking control device SC adjusts the actual wheel pressure Pw.

The braking control device SC includes the two braking units SA and SB. The first braking unit SA includes the first fluid unit YA and the first control unit EA. The first fluid unit YA is controlled by the first control unit EA using, as a power source, a storage battery BT (braking storage battery) different from the driving storage battery BG. The second braking unit SB includes the second fluid unit YB and the second control unit EB. Similarly to the first braking unit SA, the second fluid unit YB is controlled by the second control unit EB using the storage battery BT as a power source.

The first braking unit SA (in particular, the first control unit EA) and the second braking unit SB (in particular, the second control unit EB) are connected to a communication bus BS. The regenerative device KG (in particular, the regenerative control unit EG) is connected to the communication bus BS. The “communication bus BS” has a network structure in which a plurality of control units (also called “controllers”) are put from a communication line terminated at both ends. Signal transfer is performed among a plurality of controllers (EA, EB, EG, and the like) by the communication bus BS. That is, the plurality of controllers can transmit signals (detection values, calculation values, control flags, and the like) to the communication bus BS and receive signals from the communication bus BS. For example, a vehicle bus (an internal communication network that interconnects controllers in a vehicle) is adopted as the communication bus BS, and the CAN is used for a serial communication protocol. The communication bus BS includes a communication line (e.g., a CAN bus cable) and a transmission/reception microcontroller in each controller.

### <First Braking Unit SA>

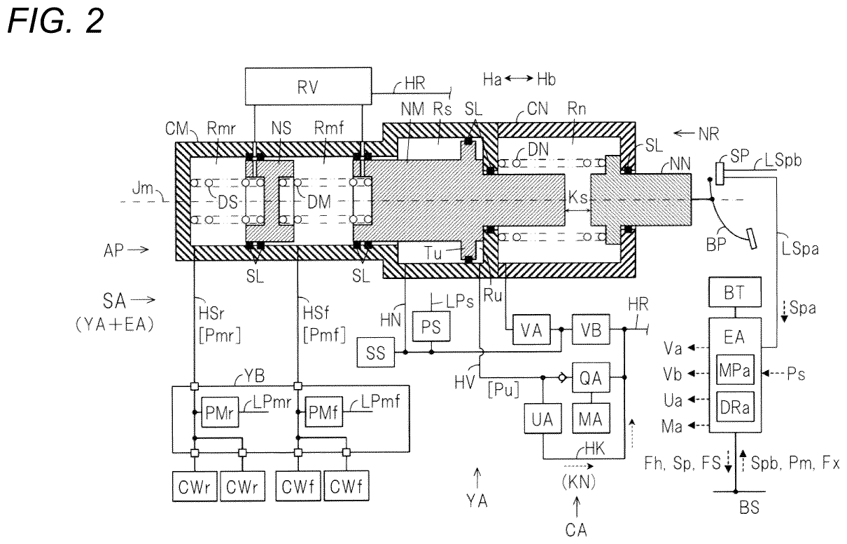

A configuration example of the first braking unit SA (corresponding to the “first unit”) of the braking control device SC will be described with reference to the schematic view of FIG. 2. The first braking unit SA generates the supply pressure Pm in accordance with the operation of the braking operation member BP (brake pedal). The supply pressure Pm is finally supplied to the wheel cylinder CW via the communication path HS (fluid path) and the second braking unit SB. The first braking unit SA includes the first fluid unit YA and the first control unit EA.

### <<First Fluid Unit YA>>

The first fluid unit YA (also called a “first actuator”) includes an application portion AP, a pressure adjusting portion CA, and an input portion NR. [Application portion AP]

The supply pressure Pm is output from the application portion AP in accordance with the operation of the braking operation member BP. The application portion AP includes a tandem master cylinder CM, and primary and secondary master pistons NM and NS.

The primary and secondary master pistons NM and NS are inserted into the tandem master cylinder CM. The inside of the master cylinder CM is sectioned into four fluid pressure chambers Rmf, Rmr, Ru, and Rs by the two master pistons NM and NS. Front wheel and rear wheel master chambers Rmf and Rmr (=Rm) are sectioned by one side bottom part of the master cylinder CM and the master pistons NM and NS. Furthermore, the inside of the master cylinder CM is partitioned into a servo chamber Ru and a reaction force chamber Rs by a flange portion Tu of the master piston NM. The master chamber Rm and the servo chamber Ru are disposed so as to face each other across the flange portion Tu. Here, a pressure receiving area rm of the master chamber Rm and a pressure receiving area ru of the servo chamber Ru are made equal.

At the time of non-braking, the master pistons NM and NS are at the most retracted positions (i.e., the position where the volume of the master chamber Rm is maximized). In this state, the master chamber Rm of the master cylinder CM communicates with a master reservoir RV. The brake fluid BF is stored inside the master reservoir RV (that is an atmospheric pressure reservoir, and also simply called a “reservoir”). When the braking operation member BP is operated, the master pistons NM and NS are moved in a forward direction Ha (direction in which the volume of the master chamber Rm decreases). By this movement, communication between the master chamber Rm and the reservoir RV is cut off. When the master pistons NM and NS are further moved in the forward direction Ha, front wheel and rear wheel supply pressures Pmf and Pmr (=Pm) are increased from “0 (atmospheric pressure)”. Due to this, the brake fluid BF pressurized to the supply pressure Pm is output (pumped) from the master chamber Rm of the master cylinder CM. Since the supply pressure Pm is the fluid pressure of the master chamber Rm, it is also called a “master pressure”.

### [Pressure Adjusting Portion CA]

The pressure adjusting portion CA supplies the servo chamber Ru of the application portion AP with a servo pressure Pu. The pressure adjusting portion CA includes a first electric motor MA, the first fluid pump QA, and the pressure adjusting valve UA.

The first electric motor MA drives the first fluid pump QA. In the first fluid pump QA, the suction portion and the discharge portion are connected by the reflux path HK (fluid path). The suction portion of the first fluid pump QA is also connected to the master reservoir RV via the reservoir path HR. The discharge portion of the first fluid pump QA is provided with a check valve.

The reflux path HK is provided with the pressure adjusting valve UA of a normally-opened type. The pressure adjusting valve UA is a linear electromagnetic valve whose valve opening amount is continuously controlled based on an energized state (e.g., supply current). Since the pressure adjusting valve UA adjusts a fluid pressure deviation (differential pressure) between the upstream side and the downstream side thereof, it is also called a “differential pressure valve”.

When the brake fluid BF is discharged from the first fluid pump QA, the circulation flow KN (indicated by the broken line arrow) of the brake fluid BF is generated in the reflux path HK. When the pressure adjusting valve UA is in a fully opened state (at the time of non-energization since the pressure adjusting valve UA is a normally-opened type), the fluid pressure Pu (called “servo pressure”) between the discharge portion of the first fluid pump QA and the pressure adjusting valve UA is “0 (atmospheric pressure)” in the reflux path HK. When the energization amount (supply current) to the pressure adjusting valve UA is increased, the circulation flow KN (flow of the brake fluid BF circulating in the reflux path HK) is throttled by the pressure adjusting valve UA. In other words, the flow path of the reflux path HK is narrowed by the pressure adjusting valve UA, and an orifice effect by the pressure adjusting valve UA is exerted. Due to this, the fluid pressure Pu on the upstream side of the pressure adjusting valve UA is increased from “0”. That is, in the circulation flow KN, a fluid pressure deviation (differential pressure) between the fluid pressure Pu (servo pressure) on the upstream side and the fluid pressure (atmospheric pressure) on the downstream side is generated with respect to the pressure adjusting valve UA. The differential pressure is adjusted by the energization amount to the pressure adjusting valve UA.

The reflux path HK is connected to the servo chamber Ru via the servo path HV (fluid path) at a portion between the discharge portion of the first fluid pump QA and the pressure adjusting valve UA. Therefore, the servo pressure Pu is introduced (supplied) to the servo chamber Ru. By the increase in the servo pressure Pu increases, the master pistons NM and NS are pressed in the forward direction Ha (direction in which the volume of the master chamber Rm decreases), and the fluid pressures Pmf and Pmr (front wheel and rear wheel supply pressures) in the front wheel and rear wheel master chambers Rmf and Rmr are increased.

Front wheel and rear wheel communication paths HSf and HSr (=HS) are connected to the front wheel and rear wheel master chambers Rmf and Rmr (=Rm). The front wheel and rear wheel communication paths HSf and HSr are connected to the front wheel and rear wheel wheel cylinders CWf and CWr (=CW) via the second braking unit SB (in particular, the second fluid unit YB). Therefore, the front wheel and rear wheel supply pressures Pmf and Pmr are supplied from the first braking unit SA to the front wheel and rear wheel wheel cylinders CWf and CWr. Here, the front wheel supply pressure Pmf and the rear wheel supply pressure Pmr are equal (i.e., “Pmf=Pmr”).

### [Input Portion NR]

The braking operation member BP is operated by the input portion NR so as to achieve the regenerative cooperative control, but a state in which the wheel pressure Pw is not generated is generated. The “regenerative cooperative control” is to cooperate the friction braking force Fm (braking force by the wheel pressure Pw) and the regenerative braking force Fg (braking force by the generator GN) so that kinetic energy of the vehicle JV can be efficiently recovered into electric energy at the time of braking. The input portion NR includes an input cylinder CN, an input piston NN, an introduction valve VA, an opening valve VB, the stroke simulator SS, and a simulator fluid pressure sensor PS.

The input cylinder CN is fixed to the master cylinder CM. The input piston NN is inserted into the input cylinder CN. The input piston NN is mechanically connected to the braking operation member BP via a clevis (U-shaped link) so as to link with the braking operation member BP (brake pedal). The end surface of the input piston NN and the end surface of the primary piston NM have a gap Ks (also called “separation displacement”). The regenerative cooperative control is achieved by adjusting the separation distance Ks by the servo pressure Pu.

An input chamber Rn of the input portion NR is connected to the reaction force chamber Rs of the application portion AP via the input path HN (fluid path). The input path HN is provided with the introduction valve VA of a normally-closed type. The input path HN is connected to the master reservoir RV via the reservoir path HR between the introduction valve VA and the reaction force chamber Rs. The reservoir path HR is provided with the opening valve VB of a normally-opened type. The introduction valve VA and the opening valve VB are on-off type electromagnetic valves. The stroke simulator SS (also simply called a “simulator”) is connected to the input path HN between the introduction valve VA and the reaction force chamber Rs.

When power supply (power feed) is not performed to the introduction valve VA and the opening valve VB, the introduction valve VA is closed, and the opening valve VB is opened. The input chamber Rn is sealed and fluidly locked by the closing of the introduction valve VA. Due to this, the master pistons NM and NS are displaced integrally with the braking operation member BP. The simulator SS communicates with the master reservoir RV by the opening of the opening valve VB. When power supply (power feed) is performed to the introduction valve VA and the opening valve VB, the introduction valve VA is opened, and the opening valve VB is closed. Due to this, the master pistons NM and NS can be displaced separately from the braking operation member BP. At this time, since the input chamber Rn is connected to the stroke simulator SS, the operation force Fp of the braking operation member BP is generated by the simulator SS.

A state in which the master pistons NM and NS and the braking operation member BP are displaced separately (at the time of energization of the electromagnetic valves VA and VB) is called the “first mode (or, a by-wire mode)”. In the first mode, the braking control device SC functions as a brake-by-wire type device (i.e., a device that can independently generate the friction braking force Fm with respect to the braking operation of the driver). Therefore, in the first mode, the wheel pressure Pw is generated independently of the operation of the braking operation member BP. On the other hand, a state in which the master pistons NM and NS and the braking operation member BP are integrally displaced (at the time of non-energization of the electromagnetic valves VA and VB) is called the “second mode (or, a manual mode)”. In the second mode, the wheel pressure Pw is linked with the braking operation of the driver. In the input portion NR, one of the first mode (by-wire mode) and the second mode (manual mode) is selected depending on the presence or absence of power feed to the introduction valve VA and the opening valve VB. When a power failure occurs in the braking control device SC (e.g., a failure or the like of the storage battery BT), the input portion NR is brought into the second mode.

The input path HN is provided with the simulator pressure sensor PS between the introduction valve VA and the reaction force chamber Rs so as to detect the fluid pressure Ps (simulator pressure) in the simulator SS. The simulator pressure sensor PS is connected to the first control unit EA by the simulator pressure signal line LPs. Therefore, the simulator pressure Ps is directly input to the first control unit EA via the simulator pressure signal line LPs.

### <<First Control Unit EA>>

The first control unit EA (also called a “first controller”) controls a first actuator YA. The first controller EA includes a first microprocessor MPa and a first drive circuit DRa. The first controller EA is connected to the communication bus BS so that signals (detection values, calculation values, control flags, and the like) can be shared with other controllers (EB, EG, and the like).

The first controller EA and the first detection portion SPa of the operation displacement sensor SP are connected via the signal line LSpa for the first detection portion SPa. The first controller EA and the simulator pressure sensor PS are connected via the signal line LPs for the simulator pressure sensor PS. The first operation displacement Spa and the simulator pressure Ps are directly input to the first controller EA through these signal lines LSpa and LPs.

A pressure adjusting control algorithm is programmed in the first controller EA (in particular, the first microprocessor MPa). The “pressure adjusting control” is a control for adjusting the supply pressure Pm (as a result, the wheel pressure Pw), and includes regenerative cooperative control. The pressure adjusting control is performed based on the first and second operation displacements Spa and Spb, the simulator pressure Ps, the supply pressure Pm, and a maximum regenerative braking force Fx.

Based on the algorithm of the pressure adjusting control, the first drive circuit DRa drives the first electric motor MA constituting the first actuator YA and various electromagnetic valves (UA and the like). In the first drive circuit DRa, an H bridge circuit is configured by switching elements (e.g., MOS-FET) so as to drive the first electric motor MA. The first drive circuit DRa includes a switching element so as to drive various electromagnetic valves (UA and the like). In addition, the first drive circuit DRa includes a motor current sensor (not illustrated) that detects a supply current Im (actual value) to the first electric motor MA, and a first current sensor (not illustrated) that detects a supply current Ia (actual value, and called a “first supply current”) to the pressure adjusting valve UA. The first electric motor MA is provided with a rotation speed sensor (not illustrated) that detects a rotation speed Na (actual value) thereof. The first electric motor MA may be provided with a rotation angle sensor (not illustrated) that detects a rotation angle Ka (actual value), and the motor rotation speed Na may be calculated based on the motor rotation angle Ka.

The first controller EA calculates a first target current Ita (target value) corresponding to the first supply current Ia based on the operation displacement Sp (operation amount). The first supply current Ia is controlled so as to be brought close to and match the first target current Ita (so-called current feedback control). The first controller EA calculates a target rotation speed Nta (target value) corresponding to the actual rotation speed Na based on the operation displacement Sp. A motor supply current Im is controlled so that the actual rotation speed Na is brought close to and matches the target rotation speed Nta (so-called rotation speed feedback control). A drive signal Ma for controlling the first electric motor MA and drive signals Ua, Va, and Vb for controlling the various electromagnetic valves UA, VA, and VB are calculated based on these control algorithms. The switching element of the first drive circuit DRa is driven in accordance with the drive signal (Ma and the like), and the first electric motor MA and the electromagnetic valves UA, VA, and VB are controlled.

### <Second Braking Unit SB>

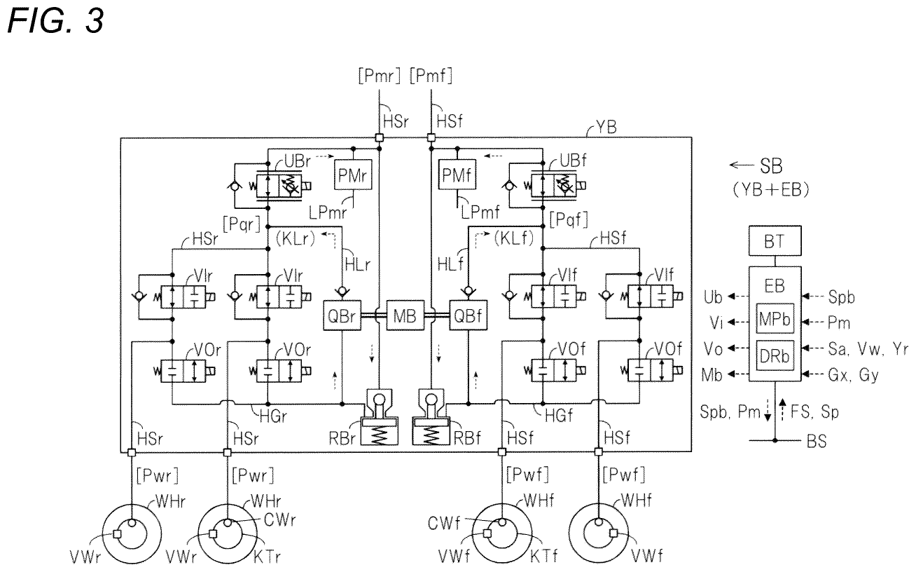

A configuration example of the second braking unit SB (corresponding to the “second unit”) of the braking control device SC will be described with reference to the schematic view of FIG. 3. The second braking unit SB is a general-purpose unit (device) for performing wheel independent control such as anti-lock brake control, traction control, and anti-skid control. In addition, the second braking unit SB performs backup control. The “backup control” is a preliminary control in preparation for an unexpected event. For example, when there is an abnormality in the operation of the first braking unit SA, the function of the first braking unit SA is replaced by the backup control, and the deterioration in the performance of the braking control device SC is compensated.

The second braking unit SB is supplied with the front wheel and rear wheel supply pressures Pmf and Pmr (=Pm) from the first braking unit SA. The front wheel and rear wheel supply pressures Pmf and Pmr are adjusted (increased or decreased) by the second braking unit SB, and are output as fluid pressures Pwf and Pwr (front wheel and rear wheel wheel pressures) of the front wheel and rear wheel wheel cylinders CWf and CWr. The second braking unit SB includes the second fluid unit YB and the second control unit EB.

### <<Second Fluid Unit YB>>

The second fluid unit YB (also called a “second actuator”) is provided between the first actuator YA and the wheel cylinder CW in the communication path HS. The second actuator YB includes the supply pressure sensor PM, the control valve UB, the second fluid pump QB, a second electric motor MB, a pressure adjusting reservoir RB, an inlet valve VI, and an outlet valve VO.

Front wheel and rear wheel control valves UBf and UBr (=UB) are provided on the front wheel and rear wheel communication paths HSf and HSr (=HS). Similarly to the pressure adjusting valve UA, the control valve UB is a normally-opened type linear electromagnetic valve (differential pressure valve). By the control valve UB, the wheel pressure Pw can be individually increased from the supply pressure Pm in a front and rear wheel system.

Front wheel and rear wheel supply pressure sensors PMf and PMr (=PM) are provided above the front wheel and rear wheel control valves UBf and UBr (portion of the communication path HS on the side near the first actuator YA) so as to detect the actual fluid pressures Pmf and Pmr (front wheel and rear wheel supply pressures) supplied from the first actuator YA (in particular, the front wheel and rear wheel master chambers Rmf and Rmr). The supply pressure sensor PM is also called a “master pressure sensor” and is built in the second actuator YB. The front wheel and rear wheel supply pressure sensors PMf and PMr are connected to the second braking unit SB (in particular, the second control unit EB) by front wheel and rear wheel supply pressure signal lines LPmf and LPmr (=LPm). That is, the signals of the front wheel and rear wheel supply pressures Pmf and Pmr (=Pm) are directly input to the second control unit EB. Since the front wheel supply pressure Pmf and the rear wheel supply pressure Pmr are substantially the same, any one of the front wheel and rear wheel supply pressure sensors PMf and PMr may be omitted. For example, in a configuration in which the rear wheel supply pressure sensor PMr is omitted, only the front wheel supply pressure Pmf is detected by the front wheel supply pressure sensor PMf, and is directly input to the second control unit EB.

Upper parts of the front wheel and rear wheel control valves UBf and UBr (portions of the communication path HS on the side near the first actuator YA) and lower parts of the front wheel and rear wheel control valves UBf and UBr (portions of the communication path HS on the side near the wheel cylinder CW) are connected by front wheel and rear wheel return paths HLf and HLr (=HL). The front wheel and rear wheel return paths HLf and HLr are provided with front wheel and rear wheel fluid pumps QBf and QBr (=QB) and front wheel and rear wheel pressure adjusting reservoirs RBf and RBr (=RB). The second fluid pump QB is driven by the second electric motor MB.

When the second electric motor MB is driven, the brake fluid BF is sucked from the upper part of the control valve UB and discharged to the lower part of the control valve UB by the second fluid pump QB. Due to this, a circulation flow KL (i.e., front wheel and rear wheel circulation flows KLf and KLr, indicated by broken line arrows) of the brake fluid BF including the pressure adjusting reservoir RB is generated in the communication path HS and the return path HL. When the control valve UB narrows the flow path of the communication path HS and throttles the circulation flow KL of the brake fluid BF, a fluid pressure Pq (called “adjustment pressure”) in the lower part of the control valve UB is increased from the fluid pressure Pm (supply pressure) in the upper part of the control valve UB by the orifice effect at that time. In other words, in the circulation flow KL, a fluid pressure deviation (differential pressure) between the fluid pressure Pm (supply pressure) on the downstream side and the fluid pressure Pq (adjustment pressure) on the upstream side with respect to the control valve UB is adjusted by the control valve UB. In the magnitude relationship between the supply pressure Pm and the adjustment pressure Pq, the adjustment pressure Pq is equal to or greater than the supply pressure Pm (i.e., “Pq>Pm”). As described above, the generation mechanism of the adjustment pressure Pq in the second actuator YB is the same as the generation mechanism of the servo pressure Pu in the first actuator YA.

Inside the second actuator YB, the front wheel and rear wheel communication paths HSf and HSr are each branched into two, and connected to the front wheel and rear wheel wheel cylinders CWf and CWr, respectively. In order to individually adjust each wheel pressure Pw, the inlet valve VI of a normally-opened type and the outlet valve VO of a normally-closed type are provided for each wheel cylinder CW. Specifically, the inlet valve VI is provided in the branched communication path HS (i.e., the side near the wheel cylinder CW with respect to the branch portion of the communication path HS). The communication path HS is connected to the pressure adjusting reservoir RB via the decompression path HG at a lower part (portion of the communication path HS on a side near the wheel cylinder CW) of the inlet valve VI. The outlet valve VO is disposed in the decompression path HG. On-off type electromagnetic valves are adopted as the inlet valve VI and the outlet valve VO. The wheel pressure Pw can be individually reduced from the supply pressure Pm at each wheel by the inlet valve VI and the outlet valve VO.

When power feed is not performed to the inlet valve VI and the outlet valve VO and their operations are stopped, the inlet valve VI is opened and the outlet valve VO is closed. In this state, the wheel pressure Pw is equal to the adjustment pressure Pq. The wheel pressure Pw is independently adjusted for each wheel cylinder CW by driving of the inlet valve VI and the outlet valve VO. In order to reduce the wheel pressure Pw, the inlet valve VI is closed and the outlet valve VO is opened. The inflow of the brake fluid BF into the wheel cylinder CW is blocked and the brake fluid BF in the wheel cylinder CW flows out to the pressure adjusting reservoir RB, and therefore the wheel pressure Pw is decreased. In order to increase the wheel pressure Pw (however, the upper limit of the increase is up to the adjustment pressure Pq), the inlet valve VI is opened and the outlet valve VO is closed. The outflow of the brake fluid BF to the pressure adjusting reservoir RB is blocked and the adjustment pressure Pq from the pressure adjusting valve UB is supplied to the wheel cylinder CW, and therefore the wheel pressure Pw is increased. In order to maintain the wheel pressure Pw, both the inlet valve VI and the outlet valve VO are closed. Since the wheel cylinder CW is fluidly sealed, the wheel pressure Pw is maintained constant.

### <<Second Control Unit EB>>

The second control unit EB (also called a “second controller”) controls the second actuator YB. Similarly to the first controller EA, the second controller EB includes a second microprocessor MPb and a second drive circuit DRb. The second controller EB is connected to the communication bus BS. Therefore, the first controller EA and the second controller EB can share signals via the communication bus BS.

The wheel speed Vw, the steering amount Sa, the yaw rate Yr, the longitudinal acceleration Gx, and the lateral acceleration Gy are input to the second controller EB (in particular, the second microprocessor MPb). The second controller EB calculates a vehicle body speed Vx based on the wheel speed Vw. The second controller EB performs wheel independent control listed below. Specifically, as the wheel independent control, anti-lock brake control (so-called ABS control) for suppressing lock of the wheel WH, traction control for suppressing spinning of a driving wheel, and anti-skid control (so-called ESC) for suppressing understeer and oversteer to improve directional stability of the vehicle are performed.

The second drive circuit DRb drives the second electric motor MB constituting the second actuator YB and various electromagnetic valves (UB and the like) in accordance with a control algorithm programmed in the second microprocessor MPb. In the second drive circuit DRb, an H bridge circuit is configured by switching elements (e.g., MOS-FET) so as to drive the second electric motor MB. The second drive circuit DRb includes a switching element so as to drive various electromagnetic valves (UB and the like). In addition, the second drive circuit DRb includes a motor current sensor (not illustrated) that detects a supply current In (actual value) to the second electric motor MB, and a second current sensor (not illustrated) that detects a supply current Ib (actual value, and called a “second supply current”) to the control valve UB. A drive signal Ub of the control valve UB, a drive signal Vi of the inlet valve VI, a drive signal Vo of the outlet valve VO, and a drive signal Mb of the second electric motor MB are calculated based on the control algorithm of the second microprocessor MPb. Based on the drive signal (Ub or the like), the second drive circuit DRb controls the second electric motor MB and the electromagnetic valves UB, VI, and VO.

The second controller EB and the second detection portion SPb of the operation displacement sensor SP are connected via the signal line LSpb for the second detection portion SPb. The second controller EB and the supply pressure sensor PM are connected via the signal line LPm (e.g., signal pin) for the supply pressure sensor PM. Therefore, the second operation displacement Spb is directly input to the second controller EB through the signal line LSpb, and the supply pressure Pm is directly input to the second controller EB through the signal line LPm. The second operation displacement Spb and the supply pressure Pm are transmitted from the second controller EB to the first controller EA through the communication bus BS. That is, in the first controller EA, the second operation displacement Spb and the supply pressure Pm are obtained from the second controller EB through the communication bus.

The second controller EB performs, in addition to the wheel independent control described above, backup control so as to cope with abnormality of the braking control device SC. In the backup control, reduction of the function and performance of the first braking unit SA is compensated by the second braking unit SB. Specifically, reduction compensation of the wheel pressure Pw, reduction of the operation force Fp of the braking operation member BP, and the like are achieved by the backup control.

### <Processing of Pressure Adjusting Control>

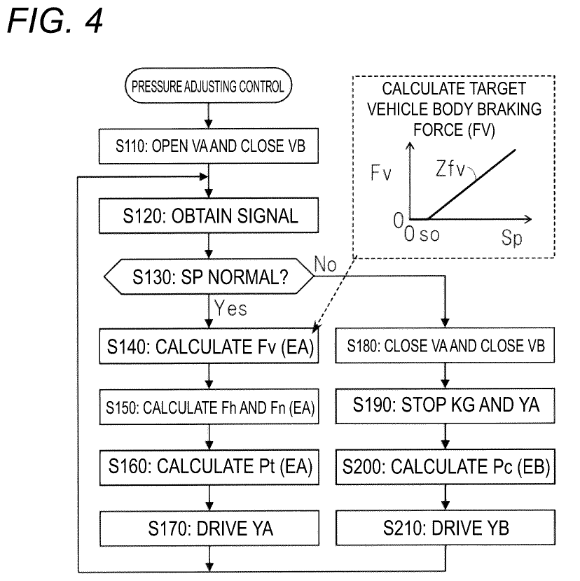

The entire processing of the pressure adjusting control will be described with reference to FIGS. 4 to 6. The pressure adjusting control includes backup control for coping with abnormality of the operation displacement sensor SP in addition to the regenerative cooperative control. An algorithm of the pressure adjusting control is programmed in the microprocessors MPa and MPb of the first and second controllers EA and EB.

In the description of a processing example, the following is assumed.
The regenerative device KG is included only on the front wheel WHf. Therefore, the regenerative braking force Fg acts on the front wheel WHf but does not act on a rear wheel WHr.
When the braking control device SC operates normally, the second actuator YB is not driven, and only the first actuator YA is driven. Therefore, since the wheel pressure Pw is adjusted only by the first actuator YA during the normal operation of the braking control device SC, the wheel pressure Pw and the supply pressure Pm match (i.e., “Pm=Pw”).
In the first actuator YA, the pressure receiving area rm (also called a “master area”) of the master chamber Rm and the pressure receiving area ru (also called a “servo area”) of the servo chamber Ru are set equally. Therefore, “rm=ru” is true, and in a static state, “Pm=Pu” is true (here, friction of a seal member SL is ignored).
The supply pressure sensor PM is built in the second actuator YB and connected to the second controller EB by the signal line LPm. The first controller EA obtains the supply pressure Pm from the second controller EB through the communication bus BS.
In the second actuator YB, the rear wheel supply pressure sensor PMr is omitted, and only the front wheel supply pressure sensor PMf is provided as the supply pressure sensor PM. Therefore, only the front wheel supply pressure Pmf is adopted as ae signal of the supply pressure Pm.

The various braking forces are as follows.
A “vehicle body total braking force Fu” is an actual braking force acting on the entire vehicle JV. The target value corresponding to the vehicle body total braking force Fu is a “target vehicle body braking force Fv”.
The “friction braking force Fm” is a braking force actually generated in accordance with the wheel pressure Pw. The target value corresponding to the friction braking force Fm is a “target friction braking force Fn”.
The “regenerative braking force Fg” is a braking force actually generated by the regenerative device KG. The target value corresponding to the regenerative braking force Fg is a “target regenerative braking force Fh”. The target regenerative braking force Fh is calculated by the first braking unit SA (in particular, the first controller) and transmitted to the regenerative device KG (in particular, the regenerative controller EG) via the communication bus BS. In the regenerative device KG, the regenerative controller EG controls the generator GN so that the actual regenerative braking force Fg is brought close to and matches the target regenerative braking force Fh.
The “limit regenerative braking force Fx” is a maximum value (limit value) of the regenerative braking force Fg that can be generated by the regenerative device KG. Therefore, in the regenerative device KG, the regenerative braking force Fg is generated in a range (limit) up to the limit regenerative braking force Fx. The limit regenerative braking force Fx is calculated by the regenerative device KG (in particular, the regenerative controller EG) and transmitted to the first braking unit SA (in particular, the first controller EA) via the communication bus BS.

The entire pressure adjusting control will be described with reference to the flowchart of FIG. 4. The algorithm of the pressure adjusting control is programmed in the microprocessors MPa and MPb of the first and second controllers EA and EB. The pressure adjusting control includes the following two in accordance with the operation state of the first braking unit SA. The first is pressure adjusting control when the operation of the braking control device SC is normal (called a “normal state”), and is called a “normal control”. The second is pressure adjusting control (i.e., backup control) when there is an abnormality in the operation displacement sensor SP (called an “abnormal state”). Here, the operation displacement sensor SP is a signal (i.e., an input signal of pressure adjusting control) for detecting a braking instruction of the driver in the brake-by-wire braking control device SC.

<<Normal Control (when Operation Displacement Sensor SP Operates Normally)>>

In step S110, power supply (power feed) is performed to the introduction valve VA and the opening valve VB by the first controller EA. Due to this, the normally-closed introduction valve VA is opened, the normally-opened opening valve VB is closed, and the first mode in which the master pistons NM and NS and the braking operation member BP can be displaced separately is selected. In the first mode, the supply pressure Pm (i.e., the wheel pressure Pw) is adjusted independently of the operation of the braking operation member BP. At this time, the operation force Fp of the braking operation member BP is generated by the stroke simulator SS.

In step S120, the first controller EA reads signals such as the first and second operation displacements Spa and Spb and the supply pressure Pm (=Pmf). The operation displacement sensor SP includes the two operation displacement detection portions SPa and SPb (first and second detection portions). The first operation displacement Spa (detection value of the first detection portion SPa) is directly obtained through the first displacement signal line LSpa. The second operation displacement Spb (detection value of the second detection portion SPb) and the supply pressure Pm (detection value of the supply pressure sensor PM) are obtained from the second controller EB via the communication bus BS.

In step S130, the first controller EA determines “whether or not the operation of the operation displacement sensor SP is normal” based on the first and second operation displacements Spa and Spb. This determination processing is called “appropriateness determination”. Specifically, the appropriateness determination is to determine “whether or not the magnitude (absolute value) of a difference hs between the first operation displacement Spa and the second operation displacement Spb, both of which are obtained, is less than a predetermined difference hs”. Here, the “predetermined difference hs” is a threshold value for determination and is a preset constant. That is, the “whether the operation of the operation displacement sensor SP is normal or abnormal” is determined on the basis of “whether the signals of both of the first and second operation displacements Spa and Spb having been output from the first and second detection portions SPa and SPb match or do not match each other”. This is based on inability of identifying which signal to be correct in a case where the signals of the first and second operation displacements Spa and Spb have been obtained but the detection value Spa (first operation displacement) of the first detection portion SPa and the detection value Spb (second operation displacement) of the second detection portion SPb do not match.

When the magnitude of the displacement difference hs is less than a predetermined difference sh (i.e., a case of “hS<sh”), it is determined that the operation of the operation displacement sensor SP is normal, and the processing proceeds to step S140. On the other hand, when the magnitude of the displacement difference hS is equal to or greater than the predetermined difference sh (i.e., a case of “hS>sh”), it is determined that the operation of the operation displacement sensor SP is abnormal, and the processing proceeds to step S180.

When any one of the first and second operation displacements Spa and Spb cannot be obtained but the other of the first and second operation displacements Spa and Spb can be obtained, the appropriateness determination is affirmed, and the processing proceeds to step S140. However, notification that the operation displacement sensor SP is malfunctioning is performed.

In step S130, when the operation of the operation displacement sensor SP is normal, the first controller EA calculates the operation displacement Sp based on the first and second operation displacements Spa and Spb. Specifically, the mean value of the first and second operation displacements Spa and Spb is determined as the operation displacement Sp (i.e., “Sp=(Spa+Spb)/2”). When one of the first and second operation displacements Spa and Spb cannot be obtained, the operation displacement Sp is determined by the other that can be obtained (i.e., “Sp=Spa” or “Sp=Spb”). Since the operation displacement sensor SP is made redundant, the operation displacement Sp is determined based on at least one of the first and second operation displacements Spa and Spb. The operation displacement Sp is transmitted from the first controller EA to the second controller EB via the communication bus BS.

In step S130, when the appropriateness determination is affirmed (i.e., the normal state of the operation displacement sensor SP), a determination flag FS is determined to be “0”. On the other hand, when the appropriateness determination is negated (i.e., the abnormal state of the operation displacement sensor SP), the determination flag FS is determined to be “1”. The “determination flag FS” is a control flag that indicates appropriateness of the operation displacement sensor SP. In the determination flag FS, “0” represents the normal state, and “1” represents the abnormal state. The determination flag FS is transmitted from the first controller EA to the second controller EB via the communication bus BS.

### <<Processing of Normal Control>>

The processing of steps S140 to S170 is the processing of normal control. This processing is performed by the first controller EA. For example, in the normal control, only the first actuator YA is driven.

In step S140, the target vehicle body braking force Fv (target value of the braking force acting on the entire vehicle) is calculated based on the operation displacement Sp and a calculation map Zfv. The target vehicle body braking force Fv is determined to be “0” when the operation displacement Sp is less than a predetermined displacement so in accordance with the calculation map Zfv. When the operation displacement Sp is equal to or greater than the predetermined displacement so, the target vehicle body braking force Fv is determined to increase from “0” as the operation displacement Sp increases from “0”. Here, the “predetermined displacement so” is a preset predetermined value (constant) representing play of the braking operation member BP.

In step S150, the target regenerative braking force Fh and the target friction braking force Fn are calculated based on the target vehicle body braking force Fv and the limit regenerative braking force Fx. Specifically, the target regenerative braking force Fh is determined as a value equal to or less than the limit regenerative braking force Fx. For example, when the target vehicle body braking force Fv is equal to or less than the limit regenerative braking force Fx, the target regenerative braking force Fh is made equal to the target vehicle body braking force Fv, and the target friction braking force Fn is determined to be “0” (i.e., when “Fv≤Fx”, “Fh=Fv, Fn=0”). On the other hand, when the target vehicle body braking force Fv is greater than the limit regenerative braking force Fx, the target regenerative braking force Fh is made equal to the limit regenerative braking force Fx, and the target friction braking force Fn is determined to be “a value in which the limit regenerative braking force Fx (=Fh) is subtracted from the target vehicle body braking force Fv” (i.e., when “Fv>Fx”, “Fh=Fx, Fn=Fv−Fx=Fv−Fh”). The target regenerative braking force Fh is transmitted from the first controller EA to the regenerative controller EG via the communication bus BS. The regenerative controller EG controls the generator GN such that the actual regenerative braking force Fg is brought close to and matches the target regenerative braking force Fh.

In step S160, the target pressure Pt (=Ptf, Ptr) is calculated based on the target friction braking force Fn. The “target pressure Pt” is a target value corresponding to the supply pressure Pm. Since “Pm=Pw” during the normal operation of the braking control device SC, the target pressure Pt is also a target value corresponding to the wheel pressure Pw. Specifically, the target pressure Pt is determined by converting the target friction braking force Fn into the dimension of the supply pressure Pm (i.e., the wheel pressure Pw) based on specifications (a pressure receiving area of the wheel cylinder CW, an effective braking radius of the rotation member KT, a friction coefficient of the friction member MS, an effective radius of the wheel (tire), and the like) of the braking device SX and the like. Since “Pmf=Pmr”, the front wheel target pressure Ptf and the rear wheel target pressure Ptr are determined to be equal values (i.e., “Ptf=Ptr”).

In step S170, the first controller EA controls the first actuator YA so that the supply pressure Pm (actual value) is brought close to and matches the target pressure Pt (target value). Specifically, the first electric motor MA is driven, and the brake fluid BF is discharged from the first fluid pump QA. Due to this, the circulation flow KN of the brake fluid BF is generated in the reflux path HK. The pressure adjusting valve UA is driven and the circulation flow KN is throttled, thereby generating the servo pressure Pu. In the driving of the first actuator YA, the pressure adjusting valve UA is controlled by feedback control based on the supply pressure Pm so that the supply pressure Pm is brought close to the target pressure Pt. When the operation displacement sensor SP is operating properly, the driving of the second actuator YB is stopped, and thus the wheel pressure Pw matches the supply pressure Pm.

### <<Processing of Backup Control>>

The backup control when there is an abnormality in the operation displacement sensor SP (i.e., in a case where the appropriateness determination in step S130 is negated) will be described. The processing in steps S180 to S210 corresponds to the backup control. In the backup control, the function of the first braking unit SA is replaced by the second braking unit SB.

When the determination in step S130 is negated, the first controller EA sets the determination flag FS to “1”. The information of “FS=1” is transmitted to the second controller EB through the communication bus BS. On the basis of the determination flag FS having been switched to “1”, the second controller EB performs the backup control. The second controller EB may perform appropriateness determination (processing of step S130) similar to that of the first controller EA, and the backup control may be started based on this. In this case, the first operation displacement Spa is obtained by the second controller EB via the communication bus BS.

In step S180, the first controller EA stops power feed to the introduction valve VA and the opening valve VB, closes the introduction valve VA, and opens the opening valve VB. Due to this, in the input portion NR, the second mode in which the master pistons NM and NS and the braking operation member BP are integrally displaced is selected. In the second mode, the friction braking force Fm is adjusted in conjunction with the operation of the braking operation member BP. Since the input chamber Rn is separated from the stroke simulator SS and is fluidly locked, the operation force Fp of the braking operation member BP is generated by the rigidity of the braking device SX or the like.

In step S190, the operations of the regenerative device KG and the first actuator YA are stopped. For example, “Fh=0” or “FS=1” is transmitted from the first controller EA to the regenerative controller EG, and in the regenerative device KG, power generation by the generator GN is stopped. Due to this, the regenerative braking force Fg is made “0”, and the regenerative cooperative control is ended. In the first braking unit SA, the power feed to the first electric motor MA and the pressure adjusting valve UA is stopped, and the servo pressure Pu is made “0”. The servo pressure Pu is generated with the operation displacement Sp as an input, but information on the input is uncertain, and therefore the first controller EA stops the operation of the first actuator YA.

In step S200, the second controller EB calculates an assist pressure Pc based on the supply pressure Pm. The “assist pressure Pc” is a target value related to the differential pressure of the control valve UB for increasing the supply pressure Pm. Specifically, the wheel pressure Pw (actual value) is increased by the amount corresponding to the assist pressure Pc from the supply pressure Pm (actual value) by the assist pressure Pc (target value).

In step S210, the second controller EB drives the second actuator YB based on the assist pressure Pc. Specifically, the second electric motor MB is driven, and the brake fluid BF is discharged from the second fluid pump QB. Due to this, the circulation flow KL of the brake fluid BF is generated in the communication path HS and the return path HL. Then, when the control valve UB is driven and the circulation flow KL is throttled, a fluid pressure deviation is generated between the upstream side and the downstream side of the control valve UB. Due to this, the adjustment pressure Pq, which is the upstream side fluid pressure, is increased from the supply pressure Pm, which is the downstream side fluid pressure. That is, in the driving of the second actuator YB, the control valve UB is controlled such that the differential pressure (i.e., the fluid pressure “Pq−Pm”) between the adjustment pressure Pq and the supply pressure Pm becomes the assist pressure Pc. Since the adjustment pressure Pq is equal to the wheel pressure Pw, the fluid pressure in which the actual fluid pressure corresponding to the assist pressure Pc (target value) is applied to the supply pressure Pm (actual value) is output as the wheel pressure Pw (actual value) from the second actuator YB (i.e., “Pw=Pm+Pc”). In other words, by the driving of the second actuator YB, the supply pressure Pm necessary for generating the wheel pressure Pw is decreased by the amount corresponding to the assist pressure Pc. Due to this, the operation force Fp of the braking operation member BP is reduced.

The braking control device SC is a brake-by-wire type device in which the operation of the braking operation member BP (brake pedal) and the fluid pressure (wheel pressure Pw) of the wheel cylinder CW can be controlled independently. Specifically, in the first braking unit SA, any one of the first mode (by-wire mode) in which the master piston NM and the braking operation member BP are displaced separately and the second mode (manual mode) in which the master piston NM and the braking operation member BP are displaced integrally is selected by the input portion NR. Due to this, the operation displacement Sp and the supply pressure Pm are independent in the first mode, and the operation displacement Sp and the supply pressure Pm are linked in the second mode. Since the supply pressure Pm is supplied as the wheel pressure Pw, the wheel pressure Pw is independently controlled with respect to the operation of the braking operation member BP by selecting the first mode.

The first braking unit SA is provided with the master cylinder CM, and the master chamber Rm and the servo chamber Ru that are partitioned by the master piston NM inserted into the master cylinder CM. As the servo pressure Pu supplied to the servo chamber Ru is increased, the supply pressure Pm is output from the master chamber Rm. When the operation of the operation displacement sensor SP is normal (case of “normal state” and “FS=0”), the first mode is selected in the first braking unit SA. The servo pressure Pu is increased based on the operation displacement Sp and the supply pressure Pm. Due to this, the supply pressure Pm is increased, and finally, the wheel pressure Pw is increased. Specifically, in the first braking unit SA, the target pressure Pt is calculated based on the operation displacement Sp (e.g., the mean value of the first and second operation displacements Spa and Spb), and the servo pressure Pu is increased so that the supply pressure Pm is brought close to the target pressure Pt. That is, in the first braking unit SA, the fluid pressure feedback control is performed so that the supply pressure Pm, which is the output, is brought close to the target pressure Pt calculated with the operation displacement Sp as an input.

On the other hand, when the operation of the operation displacement sensor SP is not normal (case of “abnormal state” and “FS=1”), the second mode is selected in the first braking unit SA. Due to this, since the master piston NM is displaced integrally with the braking operation member BP, the supply pressure Pm (as a result, the wheel pressure Pw) is generated in conjunction with the operation of the braking operation member BP. Then, in the second braking unit SB, the wheel pressure Pw is increased based on the supply pressure Pm. Specifically, in the second braking unit SB, the assist pressure Pc is calculated with the supply pressure Pm as an input, and the wheel pressure Pw is increased based on the assist pressure Pc. The assist pressure Pc is a target value corresponding to an increase amount (difference between the wheel pressure Pw and the supply pressure Pm) of the supply pressure Pm when the supply pressure Pm is increased to be the wheel pressure Pw. In the case of “FS=1”, since the input information (i.e., the operation displacement Sp) of the pressure adjusting control cannot be obtained in the first braking unit SA, the power feed to the elements (UA, MA, and the like) constituting the first actuator YA is stopped, and the servo pressure Pu is not generated. That is, the servo pressure Pu is made “0 (zero)”, and the supply pressure Pm is generated only by the muscle strength of the driver.

In the braking control device SC, the operation displacement sensor SP is provided with the two detection portions of the first and second displacement detection portions SPa and SPb. The appropriateness determination (determination of normal state/abnormal state) of the operation displacement sensor SP is performed based on a comparison result (i.e., the displacement difference hS) between the first operation displacement Spa detected by the first detection portion SPa and the second operation displacement Spb detected by the second detection portion SPb. In a case where the first and second operation displacements Spa and Spb are output but they do not match (i.e., a case of “|hS|≥hs”), it is not possible to identify which one of the first and second operation displacements SPa and SPb is normal and which of them is abnormal. In this situation, the abnormality of the operation displacement sensor SP is determined, and both the first and second operation displacements Spa and Spb are not used as input signals (information indicating a braking instruction of the driver) in the pressure adjusting control. Therefore, the supply pressure Pm is substituted as information related to the input signal for the first and second operation displacements Spa and Spb. Based on the supply pressure Pm, control (backup control) to complement the abnormality (failure) of the operation displacement sensor SP is performed.

When the supply pressure Pm is adopted as an input signal, the power feed in the first actuator YA is stopped by the first controller EA in the braking control device SC. That is, the introduction valve VA is closed, and the opening valve VB is opened. Due to this, since the input chamber Rn is sealed and fluidly locked, the master pistons NM and NS are linked with the operation of the braking operation member BP. That is, in the braking control device SC, switching from the first mode to the second mode is performed, and the brake-by-wire state is canceled. In addition, since the servo pressure Pu is not generated in the pressure adjusting portion CA, the supply pressure Pm is generated only by the muscle strength of the driver. When the operation displacement signals Spa and Spb, which are input information, are not appropriately obtained, the backup control is performed with the detection result Pm (supply pressure) of the supply pressure sensor PM as an input. In the backup control, since the supply pressure Pm is increased and output as the wheel pressure Pw, the operation force Fp necessary for obtaining the wheel pressure Pw is decreased.

As described above, the supply pressure sensor PM is built in the second actuator YB. When the operation of the operation displacement sensor SP is normal, the supply pressure Pm is adopted as information (i.e., a signal indicating a result of the feedback control) related to the output signal in the pressure adjusting control. That is, in the braking control device SC, when the operation displacement sensor SP is normal, the supply pressure sensor PM is used for output information detection of the fluid pressure feedback control. On the other hand, when the operation displacement sensor SP is abnormal, the supply pressure sensor PM is used for input information detection of the backup control. By using one supply pressure sensor PM differently in various controls, the entire device is simplified.

### <Drive Control of Pressure Adjusting Valve UA>

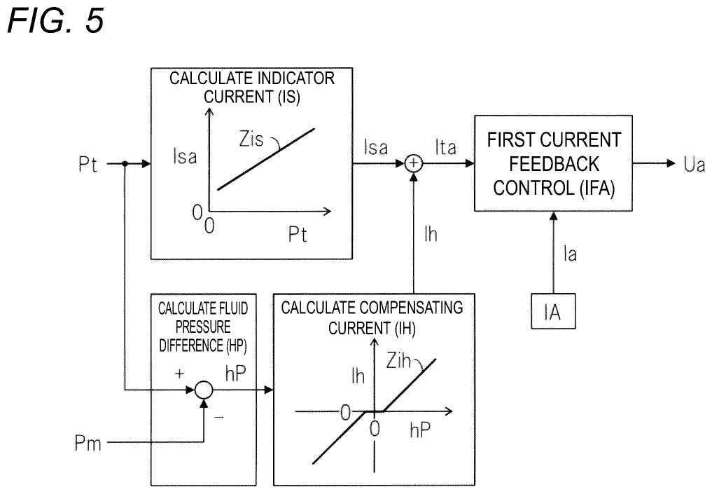

Details (in particular, the processing of step S170) of the drive control of the pressure adjusting valve UA will be described with reference to the block diagram of FIG. 5. The processing of the drive control is performed by the first controller EA in normal control. The servo pressure Pu is adjusted by the pressure adjusting valve UA, and finally the supply pressure Pm is adjusted. The drive control of the pressure adjusting valve UA includes an indicator current calculation block IS, a fluid pressure deviation calculation block HP, a compensating current calculation block IH, and a first current feedback control block IFA.

In the indicator current calculation block IS, an indicator current Isa is calculated based on the target pressure Pt and a preset calculation map Zis. The “indicator current Isa” is a target value related to the supply current Ia (first supply current) of the pressure adjusting valve UA necessary for achieving the target pressure Pt. The indicator current Isa is determined so as to increase with an increase in the target pressure Pt in accordance with the calculation map Zis. The indicator current calculation block IS corresponds to feedforward control based on the target pressure Pt.

In the fluid pressure deviation calculation block HP, a difference hP (fluid pressure deviation) between the target pressure Pt and the supply pressure Pm is calculated. Specifically, the supply pressure Pm is subtracted from the target pressure Pt to determine the fluid pressure deviation hP (i.e., “hP=Pt−Pm”).

In the compensating current calculation block IH, a compensating current Ih is calculated based on the fluid pressure deviation hP and a preset calculation map Zih. The indicator current Isa is calculated corresponding to the target pressure Pt, but an error may occur between the target pressure Pt and the supply pressure Pm. The “compensating current Ih” is for compensating (reducing) this error. The compensating current Ih is determined so as to increase with an increase in the fluid pressure deviation hP in accordance with the calculation map Zih. Specifically, when the target pressure Pt is larger than the supply pressure Pm and the fluid pressure deviation hP has a positive sign, the compensating current Ih of the positive sign is determined so that the indicator current Isa is increased. On the other hand, when the target pressure Pt is smaller than the supply pressure Pm and the fluid pressure deviation hP has a negative sign, the compensating current Ih of the negative sign is determined so that the indicator current Isa is decreased. Here, the calculation map Zih is provided with a dead zone. The compensating current calculation block IH corresponds to feedback control based on the supply pressure Pm.

The compensating current Ih is applied to the indicator current Isa, and the first target current Ita is calculated (i.e., “Ita=Isa+Ih”). The “first target current Ita” is a final target value of the current supplied to the pressure adjusting valve UA. That is, the first target current Ita is determined as the sum of a feedforward term Isa and a feedback term Ih. Therefore, the drive control of the pressure adjusting valve UA includes feedforward control (processing of the indicator current calculation block IS) and feedback control (processing of the compensating current calculation block IH) in the fluid pressure.

In the first current feedback control block IFA, the first drive signal Ua is calculated such that the first supply current Ia is brought close to and matches the first target current Ita based on the first target current Ita (target value) and the first supply current Ia (actual value). Here, the first supply current Ia is detected by the first supply current sensor IA provided in the first drive circuit DRa. In the first current feedback control block IFA, if “Ita>Ia”, the first drive signal Ua is determined such that the first supply current Ia increases. On the other hand, if “Ita<Ia”, the first drive signal Ua is determined such that the first supply current Ia decreases. That is, in the first current feedback control block IFA, feedback control related to current is performed. Therefore, the drive control of the pressure adjusting valve UA includes feedback control related to the current in addition to feedback control related to the fluid pressure.

### <Drive Control of Control Valve UB>

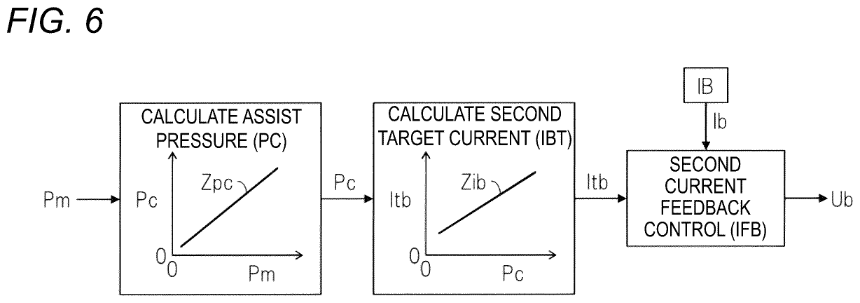

Details (in particular, the processing in steps S200 and S210) of the drive control of the control valve UB will be described with reference to the block diagram of FIG. 6. The processing of the drive control is performed by the second controller EB in backup control. When it is determined that the operation displacement sensor SP is normal (i.e., a case of “FS=0”), the operation of the second actuator YB is stopped, and power feed is not performed to the second electric motor MB and the control valve UB. At the time point when an abnormality of the operation displacement sensor SP is determined (i.e., switching time point from “FS=0” to “FS=1”), the operation of the first actuator YA is stopped. The power feed of the introduction valve VA and the opening valve VB is stopped, and the operation mode of the input portion NR is switched from the first mode to the second mode. The power feed to the pressure adjusting valve UA is stopped, and the servo pressure Pu is made “0”. At this time, the second braking unit SB drives the second electric motor MB and the control valve UB, and starts the backup control. The drive control of the control valve UB in the backup control includes an assist pressure calculation block PC, a second target current calculation block IBT, and a second current feedback control block IFB.

In the assist pressure calculation block PC, the assist pressure Pc is calculated based on the supply pressure Pm and a preset calculation map Zpc. The “assist pressure Pc” is a target value for increasing the wheel pressure Pw from the supply pressure Pm. Specifically, it is a target value of the differential pressure between the supply pressure Pm and the adjustment pressure Pq (i.e., the wheel pressure Pw). The assist pressure Pc is determined so as to increase with an increase in the supply pressure Pm in accordance with the calculation map Zpc. As the supply pressure Pm is increased by the assist pressure Pc, the operation force Fp of the braking operation member BP is reduced.

In the second target current calculation block IBT, a second target current Itb is calculated based on the assist pressure Pc (target value) and a preset calculation map Zib. The “second target current Itb” is a target value related to the supply current Ib (second supply current) of the control valve UB necessary for generating a differential pressure corresponding to the assist pressure Pc by the control valve UB. The second target current Itb is determined so as to increase with an increase in the assist pressure Pc in accordance with the calculation map Zib. The processing of the second target current calculation block IBT is similar to the processing of the indicator current calculation block IS described above (i.e., feedforward control based on fluid pressure).

In the second current feedback control block IFB, the second drive signal Ub is calculated such that the second supply current Ib is brought close to and matches the second target current Itb based on the second target current Itb (target value) and the second supply current Ib (actual value). Here, the second supply current Ib is detected by a second supply current sensor IB provided in the second drive circuit DRb. In the second current feedback control block IFB, if “Itb>Ib”, the second drive signal Ub is determined such that the second supply current Ib increases. On the other hand, if “Itb<Ib”, the second drive signal Ub is determined such that the second supply current Ib decreases. In the second current feedback control block IFB, feedback control related to the current similar to the first current feedback control block IFA described above is performed.

Although the drive control of the control valve UB described above is open loop control, feedback control related to fluid pressure may be included and may be configured as closed loop control. In this configuration, an adjustment pressure sensor is provided below the control valve UB so as to detect the adjustment pressure Pq. The second target current Itb is finely adjusted based on the difference between the supply pressure Pm and the adjustment pressure Pq by a similar method to the compensating current calculation block IH.

In the backup control, the front wheel wheel pressure Pwf may be adjusted to be higher than the rear wheel wheel pressure Pwr. Specifically, a front wheel assist pressure Pcf is calculated to be larger than a rear wheel assist pressure Pcr. Supply currents Ibf and Ibr of the front wheel and rear wheel control valves UBf and UBr are individually adjusted based on the front wheel and rear wheel assist pressures Pcf and Pcr. By adjusting the front wheel wheel pressure Pwf to be larger than the rear wheel wheel pressure Pwr, the vehicle stability in the backup control is further improved.

### <Configuration of Two-System Pressure Adjusting>

In the above-described embodiment, when the operation displacement sensor SP is normal, the operation of the second actuator YB is stopped, and only the first actuator YA is driven. In this case, since the front wheel and rear wheel supply pressures Pmf and Pmr (=Pm) are equal, the front wheel and rear wheel wheel pressures Pwf and Pwr (=Pw) are equal. Such pressure adjusting control is called “one-system pressure adjusting”. In the configuration of the one-system pressure adjusting, since the second actuator YB is not driven in the normal control, a target pressure Ptm (called “target supply pressure”) corresponding to the supply pressure Pm and a target pressure Ptw (called “target wheel pressure”) corresponding to the wheel pressure Pw match (i.e., “Pt=Ptm=Ptw”).

In place of the configuration of the one-system pressure adjusting, the second actuator YB may be driven in addition to the first actuator YA when the operation displacement sensor SP is normal, and the front wheel and rear wheel wheel pressures Pwf and Pwr may be adjusted separately. Specifically, the identical supply pressures Pmf and Pmr (=Pm) are supplied from the first actuator YA to the second actuator YB. The wheel pressure (e.g., the front wheel wheel pressure Pwf) of one side system corresponding to the wheel including the regenerative device KG is adjusted by the second actuator YB to be smaller than the wheel pressure (e.g., the rear wheel wheel pressure Pwr) of the other side system corresponding to the wheel not including the regenerative device KG. The pressure adjusting control in which the front wheel and rear wheel wheel pressures Pwf and Pwr are independently and individually adjusted by the drive of the second actuator YB is called “two-system pressure adjusting”. In regenerative cooperative control, as compared with the one-system pressure adjusting, the two-system pressure adjusting improves the regenerative efficiency and optimizes the braking force distribution between the front and rear wheels.

In the configuration of the two-system pressure adjusting, since the second actuator YB is driven even in the normal state, the target pressure Ptm (target supply pressure) corresponding to the supply pressure Pm and the target pressure Ptw (target wheel pressure) corresponding to the wheel pressure Pw are different. Therefore, the first actuator YA performs feedforward control and feedback control so that the supply pressure Pm (=Pmf, Pmr) is brought close to and matches the target supply pressure Ptm. The second actuator YB performs feedforward control based on differential pressures hPf and hPr (called “front wheel and rear wheel target differential pressure”) between front wheel and rear wheel target wheel pressures Ptwf and Ptwr and the target supply pressure Ptm (or the actual supply pressure Pm).

The configuration of the two-system pressure adjusting is also applied with backup control. When the operation of the operation displacement sensor SP is abnormal, the regenerative cooperative control is ended, and the generation of the regenerative braking force Fg is stopped. The first controller EA selects the second mode in the input portion NR. The second controller EB calculates the assist pressure Pc (target value corresponding to an increase amount from the supply pressure Pm) based on the supply pressure Pm. In the backup control, the supply pressure Pm is increased by an amount corresponding to the assist pressure Pc (target value) based on the assist pressure Pc by the second actuator YB, and is output as the wheel pressure Pw. This reduces the operation force Fp of the driver. In the braking control device SC, the supply pressure Pm is used as information related to output (i.e., result information of feedback control) in the normal control, and is used as information related to input (i.e., information related to braking instruction of the driver) in the backup control. Since the role of one supply pressure sensor PM is appropriately used differently, the device configuration can be simplified. Also in the backup control in the configuration of the two-system pressure adjusting, the front wheel wheel pressure Pwf can be adjusted to be larger than the rear wheel wheel pressure Pwr in order to improve the vehicle stability.

### Other Embodiments

Hereinafter, other embodiments will be described. Other embodiments also achieve similar effects to those described above (performing of backup control when the operation displacement Sp cannot be appropriately obtained, simplification of the device configuration based on usage of the supply pressure sensor PM, and the like).

In the above-described embodiment, the target values (Fv, Fx, Fh, Fn, and the like) of various braking forces are calculated by the dimension of the longitudinal force acting on the vehicle JV. Alternatively, they may be calculated by the dimension of deceleration of the vehicle JV or the dimension of torque of the wheel WH. This is based on the fact that the state quantity (called “state quantity related to force”) from the longitudinal force to the vehicle deceleration is equivalent. Therefore, the target pressure Pt is calculated based on the state quantity related to the force from the longitudinal force acting on the vehicle JV to the deceleration of the vehicle JV.

In the above-described embodiment, the front-rear type is adopted as the two-system braking system. Alternatively, a diagonal type (also called “X type”) may be adopted as the two-system braking system. In this configuration, one of the two master chambers Pm is connected to the left front wheel wheel cylinder and the right rear wheel wheel cylinder, and the other of the two master chambers Pm is connected to the right front wheel wheel cylinder and the left rear wheel wheel cylinder. However, in the configuration in which the two-system pressure adjusting is adopted, the braking system is limited to the front-rear type.

In the above-described embodiment, the supply pressure sensor PM is built in the second actuator YB and connected to the second controller EB. The first controller EA obtains the supply pressure Pm through the communication bus BS. Conversely, the supply pressure sensor PM may be built in the first actuator YA and connected to the first controller EA. In this configuration, when performing the backup control, the second controller EB obtains the supply pressure Pm through the communication bus BS. However, the former configuration is more advantageous than the latter configuration in terms of function dispersion and fail-safe.

In the above-described embodiment, as the pressure adjusting portion CA, one (so-called reflux type configuration) that adjusts the servo pressure Pu by the pressure adjusting valve UA throttling the circulation flow KN of the brake fluid BF discharged from the fluid pump QA has been exemplified. Alternatively, in the pressure adjusting portion CA, the pressure accumulated in an accumulator may be adjusted by a linear electromagnetic valve (so-called accumulator type configuration). The volume in the cylinder may be increased or decreased by the piston directly driven by the electric motor to adjust the servo pressure Pu (so-called electric cylinder type configuration). In any configuration, the supply pressure Pm is fed back as an output signal by the pressure adjusting portion CA, and the fluid pressure Pu (servo pressure) of the servo chamber Ru is electrically adjusted.

In the above-described embodiment, the tandem type is exemplified as the master cylinder CM. Alternatively, a single type master cylinder CM may be adopted. In this configuration, the secondary master piston NS is omitted. One master chamber Rm is connected to the four wheel cylinders CW. In this configuration, the identical supply pressures Pmf and Pmr (=Pm) are output from the master cylinder CM.

In the configuration adopting the single type master cylinder CM, the master chamber Rm may be connected to the front wheel wheel cylinder CWf, and the rear wheel wheel cylinder CWr may be directly supplied with the servo pressure Pu from the pressure adjusting portion CA. In this configuration, the front wheel supply pressure Pmf is output from the master cylinder CM. On the other hand, the servo pressure Pu is output as the rear wheel supply pressure Pmr from the pressure adjusting portion CA.

In the above-described embodiment, the operation of the first actuator YA is stopped in the backup control. Alternatively, also in the backup control, drive of “constituent elements (i.e., the first electric motor MA and the pressure adjusting valve UA) included in pressure adjusting portion CA and for increasing the supply pressure Pm” may be continued after output thereof is decreased (reduced) as compared with the case of normal control. Due to this, since the servo pressure Pu is slightly generated also in the backup control, there is an effect of reducing the operation force Fp. Alternatively, the power feed to the pressure adjusting valve UA is completely stopped, but the power feed to the first electric motor MA may be continued. In this case, in the backup control, the first electric motor MA continues to be driven at a low rotation speed nx. Here, the “low rotation speed nx” is a predetermined value (constant) set in advance, and is an extremely small value (a predetermined rotation speed sufficient for ensuring startup responsiveness of the electric motor MA) as compared with the rotation speed of the first electric motor MA in the normal control. As the drive of the first electric motor MA is continued, the normal control can be quickly resumed when returning to the normal state. In the backup control, even if the power feed to the first electric motor MA or the like is continued, the power feed to the introduction valve VA and the opening valve VB is stopped, and the operation mode of the input portion NR is set to the second mode.

In the above-described embodiment, the pressure receiving area rm (master area) of the master chamber Rm and the pressure receiving area ru (servo area) of the servo chamber Ru are set equally in the application portion AP. The master area rm and the servo area ru need not be equal. In the configuration in which the master area rm and the servo area ru are different, conversion calculation between the supply pressure Pm and the servo pressure Pu is possible based on the ratio between the servo area ru and the master area rm (i.e., conversion based on “Pm·rm=Pu·ru”).

In the above-described embodiment, in the first braking unit SA, the supply pressure Pm is output via the master cylinder CM. That is, the application portion AP and the pressure adjusting portion CA are arranged in series in the transfer route of the fluid pressure, and the servo pressure Pu supplied from the pressure adjusting portion CA is transmitted as the supply pressure Pm via the master piston NM. Alternatively, the application portion AP and the pressure adjusting portion CA may be arranged in parallel. Specifically, each of the application portion AP (in particular, the master cylinder CM) and the pressure adjusting portion CA is directly connected to the second actuator YB. In the first mode, “connection between the pressure adjusting portion CA and the second actuator YB” is selected, and in the second mode, “connection between the application portion AP and the second actuator YB” is selected. For example, the selection is achieved by an on/off electromagnetic valve (called a “selector valve”). In the first mode in the configuration, the servo pressure Pu generated in the pressure adjusting portion CA is directly output as the supply pressure Pm not via the application portion AP. At this time, the application portion AP is connected to the stroke simulator SS, and the operation force Fp of the braking operation member BP is generated by the simulator SS. On the other hand, in the second mode, the fluid pressure in the master chamber Rm generated by the operation of the braking operation member BP is output as the supply pressure Pm. At this time, the application portion AP is separated from the simulator SS.

In the above-described embodiment, the braking control device SC is applied to the vehicle JV in which the rear wheel WHr does not include the regenerative device KG. The braking control device SC may be applied to the vehicle JV in which the rear wheel WHr includes the regenerative device KG.

### Summary of Embodiments

Hereinafter, embodiments of the braking control device SC will be summarized. The braking control device SC is a brake-by-wire type device that can independently adjust the operation displacement Sp of the braking operation member BP and the fluid pressure Pw (wheel pressure) of the wheel cylinder CW.

The braking control device SC includes the “first braking unit SA (first unit) that outputs the supply pressure Pm in accordance with the operation displacement Sp of the braking operation member BP”, the “second braking unit SB (second unit) that is provided between the first braking unit SA and the wheel cylinder CW, and increases the supply pressure Pm and outputs the wheel pressure Pw to the wheel cylinder CW”, the “operation displacement sensor SP (displacement sensor) that detects the operation displacement Sp”, and the “supply pressure sensor PM that detects the supply pressure Pm”. Here, the first braking unit SA selects any one of the first mode in which the operation displacement Sp and the supply pressure Pm are independent and the second mode in which the operation displacement Sp and the supply pressure Pm are linked.

In the braking control device SC, the appropriateness determination of “whether the operation displacement sensor sp is in a normal state or an abnormal state” is performed by at least one of the first and second braking units SA and SB (in particular, the first and second controllers EA and EB). Specifically, the operation displacement sensor SP includes, as the operation displacement Sp, the first and second detection portions SPa and SPb that output the first and second displacement signals Spa and Spb (first and second operation displacements). When both the first and second displacement signals Spa and Spb are output, the first displacement signal Spa and the second displacement signal Spb are compared. The normal state is determined when the magnitude (=|Spa−Spb|) of the difference hs between the first and second displacement signals Spa and Spb is less than the predetermined displacement hs (preset constant), and the abnormal state is determined when the magnitude (=|Spa−Spb|) of the difference hS between the first and second displacement signals Spa and Spb is equal to or greater than the predetermined displacement hs. This is because it is difficult to judge which of the detection values Spa and Spb is appropriate when the outputs Spa and Spb (detection values) from the two detection portions SPa and SPb are different.

In the braking control device SC, when the operation displacement sensor SP is normal (case of the normal state), the first mode is selected in the first braking unit SA. The supply pressure Pm is increased based on the operation displacement Sp by the first braking unit SA. For example, in the first braking unit SA, the target pressure Pt is calculated based on the operation displacement Sp, and the wheel pressure Pw is increased so as to be brought close to the target pressure Pt by the fluid pressure feedback control based on the supply pressure Pm.

When the operation displacement sensor SP is not normal (case of an abnormal state), the second mode is selected in the first braking unit SA. In the abnormal state, since the input signal (i.e., the operation displacement Sp) cannot be used, the power feed to the constituent elements (UA, MA, and the like) included in the first braking unit SA (in particular, the pressure adjusting portion CA) and for increasing the supply pressure Pm is stopped. Therefore, the supply pressure Pm is generated only by the muscle strength of the driver. Alternatively, the power feed amount to the constituent elements of the pressure adjusting portion CA is reduced as compared with the case of the normal control. That is, also in the abnormal state, the output of the pressure adjusting portion CA is decreased as compared with the normal state and the driving is continued (e.g., drive of the first electric motor MA at the low rotation speed nx). In any case, the output (i.e., the supply pressure Pm) from the first braking unit SA decreases.

In the braking control device SC, backup control is performed so as to compensate for the decrease in output from the first braking unit SA. Specifically, the second braking unit SB increases the wheel pressure Pw based on the supply pressure Pm. For example, in the second braking unit SB, the assist pressure Pc (target value) is calculated based on the supply pressure Pm, and the wheel pressure Pw is increased based on the assist pressure Pc. That is, when the operation displacement signal Sp (operation displacement) is not appropriately obtained, the decrease amount of the supply pressure Pm is compensated by pressurization by the second control unit SB with the detection result Pm (supply pressure) of the supply pressure sensor PM as an input signal. Therefore, even if an abnormality occurs in the operation displacement sensor SP, the operation force Fp of the braking operation member BP necessary for securing the wheel pressure Pw is decreased, and the vehicle deceleration can be appropriately secured.

In the braking control device SC, when the operation displacement sensor SP is normal, the supply pressure Pm is treated as an output signal in the normal control (output signal of the feedback control related to the fluid pressure) in the first control unit SA (in particular, the first controller EA). On the other hand, when the operation displacement sensor SP is abnormal, the supply pressure Pm is treated as an input signal of backup control (input signal for calculating the assist pressure Pc (i.e., the second target current Itb)) in the second control unit SB (in particular, the second controller EB). Since the detection value Pm of one supply pressure sensor PM is appropriately used differently on the basis of the result of the appropriateness determination, the configuration of the entire device can be simplified.

1. A braking control device for a vehicle comprising:
a first unit that outputs a supply pressure in accordance with an operation displacement of a braking operation member;
a second unit that is provided between the first unit and a wheel cylinder, increases the supply pressure, and outputs a wheel pressure to the wheel cylinder;
a displacement sensor that detects the operation displacement; and
a supply pressure sensor that detects the supply pressure, wherein
the first unit selects any one of a first mode in which the operation displacement and the supply pressure are independent and a second mode in which the operation displacement and the supply pressure are linked,
in a case of a normal state where the displacement sensor is normal, the first unit selects the first mode and increases the supply pressure based on the operation displacement, and
in a case of an abnormal state where the displacement sensor is not normal, the first unit selects the second mode, and the second unit increases the wheel pressure based on the supply pressure.

2. The braking control device for a vehicle according to claim 1, wherein
the first unit calculates a target pressure based on the operation displacement and increases the supply pressure so as to be brought close to the target pressure, and
the second unit calculates an assist pressure based on the supply pressure and increases the wheel pressure based on the assist pressure.

3. The braking control device for a vehicle according to claim 2, wherein
the displacement sensor includes, as the operation displacement, first and second detection portions that output first and second displacement signals, and
at least one of the first and second units determines the abnormal state when a magnitude of a difference between the first displacement signal and the second displacement signal is equal to or greater than a predetermined value.

4. The braking control device for a vehicle according to claim 1, wherein
the displacement sensor includes, as the operation displacement, first and second detection portions that output first and second displacement signals, and
at least one of the first and second units determines the abnormal state when a magnitude of a difference between the first displacement signal and the second displacement signal is equal to or greater than a predetermined value.
